(19) United States
(12) Patent Application Publication
(10) Pub. No.: US 2015/0325121 A1
(43) Pub. Date: Nov. 12, 2015

(54) METHODS AND SYSTEMS FOR DECISION SUPPORT

(71) Applicant: GM Global Technology Operations LLC, Detroit, MI (US)

(72) Inventors: AMIR KONIGSBERG, HERZLIYA PITUACH (IL); CLAUDIA V. GOLDMAN-SHENHAR, MEVASSERET ZION (IL)

(73) Assignee: GM GLOBAL TECHNOLOGY OPERATIONS LLC, Detroit, MI (US)

(21) Appl. No.: 14/275,533

(22) Filed: May 12, 2014

(51) Int. Cl. G08G 1/0962

(52) U.S. Cl. CPC G08G 1/0962

(57) ABSTRACT

Methods and systems are provided for providing decision support. In one embodiment, a method includes: receiving a recommendation associated with a vehicle; receiving contextual data associated with the vehicle; determining a risk factor based on the recommendation and the contextual data; and generating notification data based on the risk factor to notify a user of the vehicle of the risk factor associated with the recommendation.

### TECHNICAL FIELD

The technical field generally relates to methods and systems for providing decision support and in particular to methods and systems for providing recommendations and decision support in an automotive context.

### BACKGROUND

Various vehicle systems make recommendations to a user of the vehicle. For example, a navigation system may make a recommendation of destinations, time to destination, mileage, etc. In another example, automated or semi-automated driving systems may make recommendations of a particular speed or driving maneuver that is being performed or that can be performed by the vehicle. The user is notified of these recommendations and typically makes a decision of whether or not to follow the recommendation. The user typically makes the decision based on his own best judgment.

Accordingly, it is desirable to provide methods and systems for providing decision support with the recommendations and presenting the recommendations and the decision support to a user of the vehicle. In addition, other desirable features and characteristics of the present invention will become apparent from the subsequent detailed description and the appended claims, taken in conjunction with the accompanying drawings and the foregoing technical field and background.

### SUMMARY

Methods and systems are provided for providing decision support. In one embodiment, a method includes: receiving a recommendation associated with a vehicle; receiving contextual data associated with the vehicle; determining a risk factor based on the recommendation and the contextual data; and generating notification data based on the risk factor to notify a user of the vehicle of the risk factor associated with the recommendation.

In one embodiment, a system includes a first module and a second module. The first module determines a risk factor based on a recommendation associated with a vehicle and contextual data associated with the vehicle. The second module generates notification data based on the risk factor to notify a user of the vehicle of the risk factor associated with the recommendation.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a recommendation system that is implemented in a vehicle in accordance with various embodiments;

FIG. 2 is a dataflow diagram illustrating a control module of the recommendation system in accordance with various embodiments; and

FIG. 3 is a flowchart illustrating recommendation methods that may be performed by the recommendation system of FIG. 1 in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

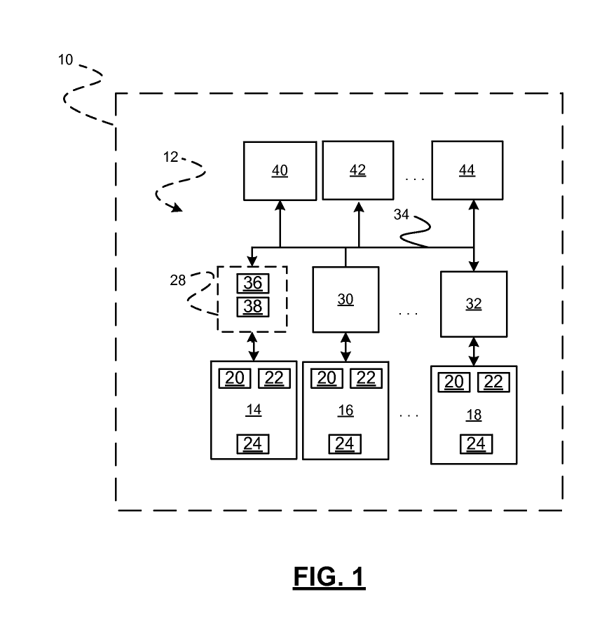

FIG. 1 is a functional block diagram of a vehicle 10 that includes a recommendation system 12 in accordance with various embodiments. As can be appreciated, the exemplary vehicle 10 may be an automobile, an aircraft, a spacecraft, a watercraft, a sport utility vehicle, or any other type of vehicle. Although the figures shown herein depict an example with certain arrangements of elements, additional intervening elements, devices, features, or components may be present in actual embodiments. It should also be understood that FIG. 1 is merely illustrative and may not be drawn to scale.

As shown, the vehicle 10 includes one or more vehicle systems 14-18 including, but not limited to, a steering system, a powertrain system, a heating and cooling system, an infotainment system, or any vehicle system. Each vehicle system 14-18 generally includes one or more sensors 20 that sense observable conditions of the vehicle 10, one or more mechanical or electro-mechanical components 24, and one or more actuators 26 that control the one or more electro-mechanical components 24 of the vehicle 10.

One or more control modules 28-32 may be associated wither the vehicle systems 14-18. For example, a single control module 28 may be associated with a single vehicle system 14 (as shown), a single control module 28 may be associated with all of the vehicle systems 14-18, or multiple control modules 28, 30 may be implemented for one or a combination of vehicle systems 14-18. In any of the examples, the control modules 28-32 generally receive sensor signals from the sensors 20 and generate control signals to the actuators 26 based on the sensor signals. When the vehicle 10 includes multiple control modules 28-32 (as shown), the control modules 28-32 communicate over a vehicle communication bus 34.

In various embodiments, at least one of the control modules 28 includes a recommendation module 36; and at least one of the control modules 28 includes a risk factor determination module 38. For exemplary purposes, the control module 28 is shown to include both the recommendation module 36 and the risk factor determination module 38. As can be appreciated, in various embodiments the recommendation module 36 and the risk factor determination module 38 can be implemented in separate control modules (not shown). As can further be appreciated, the recommendation module 36 and/or the risk factor determination module 38 can each be implemented for each control module 28-32, can be implemented for a combination of control modules 28-32, and/or can be implemented for all control modules 28-32.

The recommendation module 36 processes data from the sensors 20 and/or data received from other control modules 30-32 to produce a recommendation. The recommendation may be, for example, a suggestion to perform a particular driving maneuver (e.g., a speed, a passing maneuver, a parking maneuver, etc.), a suggestion that a particular driving maneuver has been detected as being performed (e.g., a speed, a passing maneuver, a parking maneuver, etc.), navigation information (e.g., a destination, a time to destination, etc.), or any other information that may be presented to a driver for evaluation.

The risk factor determination module 38 receives the recommendation and notifies a user of the vehicle 10 of a risk factor associated with the recommendation. The risk factor indicates a confidence in the recommendation, or a risk level in relation to some aspect that is associated with the recommendation. The risk factor determination module 38 determines the risk factor based on contextual data associated with the recommendation. The contextual data may include, but is not limited to, vehicle data (e.g., vehicle speed, acceleration, etc.), ambient conditions associated with the vehicle 10 (e.g., weather conditions, visibility, traffic information, road type, etc.), and/or driver data (e.g., driver detected fatigue, driver preferences, etc.). The risk factor determination module 38 notifies the user of the risk factor of the recommendation by generating control signals and/or data messages to one or more notification devices 40-44 of the vehicle 10. The notification devices 40-44 may include, but are not limited to, a display device, an audio device, and/or a haptic device that is associated with or separate from one of the vehicle systems 14-18 or other vehicle element.

As can be appreciated, the display device may be a display screen (e.g., a screen of an infotainment system or other system), a heads-up display that is projected on a windshield or other location of the vehicle 10, or a display indicator of a cluster or other system of the vehicle 10. The audio device may be an audio speaker of an infotainment system or other system of the vehicle 10. The haptic device may be a vibration device or other sensory device of a seat system, a steering system, an infotainment system, or other system of the vehicle 10.

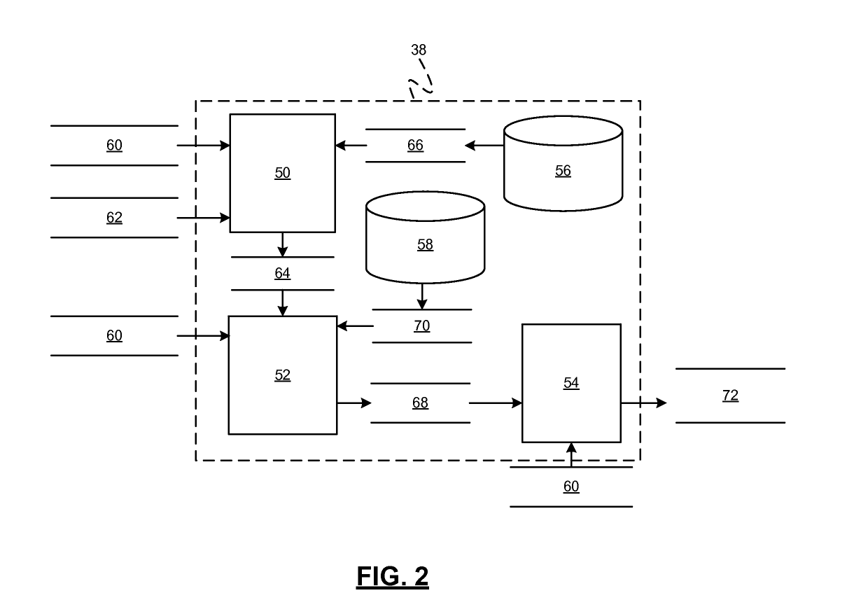

Referring now to FIG. 2 and with continued reference to FIG. 1, a dataflow diagram illustrates the risk factor determination module 38 in accordance with various embodiments. Various embodiments of the risk factor determination module 38 according to the present disclosure may include any number of sub-modules. As can be appreciated, the sub-modules shown in FIG. 2 may be combined and/or further partitioned to similarly process contextual data to provide a risk factor associated with a particular recommendation. Inputs to the risk factor determination module 38 may be received from the sensors 20 of the vehicle 10, received from other control modules 30-32 of the vehicle 10, and/or determined by other sub-modules (not shown) of the control module 28. In various embodiments, the risk factor determination module 38 includes a data source score determination module 50, a risk factor determination module 52, a notification data generation module 54, a scoring rules data datastore 56, and a risk factor rules data datastore 58.

The data source score determination module 50 receives as input one or more recommendations 60, and contextual data 62 associated with the one or more recommendations 60. For exemplary purposes, the disclosure will be discussed in the context of a single recommendation being provided. As discussed above, the recommendation 60 may be determined by a control module 28-32 and may include, for example, a driving maneuver (e.g., a speed, a passing maneuver, a parking maneuver, etc.), navigation information (e.g., a destination, a time to destination, etc.), or other information that may be presented to a driver for evaluation. As discussed above, the contextual data 62 may include vehicle data (e.g., vehicle speed, acceleration, etc.), ambient conditions associated with the vehicle 10 (e.g., weather conditions, visibility, traffic information, road type, etc.), and/or driver data (e.g., driver detected fatigue, driver preferences, etc.).

The data source score determination module 50 determines a score 64 for each data source of the contextual data 62. When multiple recommendations 60 are provided, the data source score determination module 50 determines a score 64 for each data source of the contextual data 62 that is associated with each recommendation 60. The data source score determination module 50 determines the score 64 based on scoring rules 66 stored in the scoring rules data datastore 56. The scoring rules data datastore 56 may store one or more scoring rules 66 for each data source. For example, the scoring rules 66 are defined for each data source in relation to a parameter the data source measures. The scoring rules 66 may be based on a peak value of the parameter, an average value of the parameter, a defined curve of the parameter, or a summation of the parameter.

For example, given contextual data 62 that includes data from three data sources associated with the recommendation: data source (a), data source (b), and data source (c), scoring rules 66 for each of the data sources (a), (b), and (c) are retrieved from the scoring rules data datastore 56. The data for the data source (a) is evaluated according to the rules 66 associated with the data source (a). The data for the data source (b) is evaluated according to the rules 66 associated with the data source (b). The data for the data source (c) is evaluated according to the rules 66 associated with the data source (c).

Say, for example, data source (a) is vehicle speed, data source (b) is road type, and data source (c) is weather, and each data source is given a score between one and five. The score 64 for (a) can be determined based on scoring rules 66 defining varying speed-range thresholds. For example, if Xkm/h<a<Ykm/h, set score to 1; if Ykm/h<a<Zkm/h set score to 2; and so on. The score 64 for (b) can be determined based on scoring rules 66 defining road types (e.g., straight road, curvature, etc.) and conditions (e.g., ditches, road-works, single/multi-lane, etc.). For example, if the road is perfectly straight with perfect conditions, set score to 1; if the road type has minor curvature and/or minor ditches, set score to 2; if the road type has major curvature, set score to 3, 4, or 5, depending on the degree of curvature; and if the road type has significant road-conditions such as a single lane and/or road works, set score to 3, 4, or 5, in respect to its severity. The score 64 for (c) can be determined based on scoring rules 66 defining the weather conditions. For example, if the sun is shining and there is perfectly clear visibility, set score to 1; if there is a light drizzle of rain, but clear visibility, set score to 2; if the road is damp and there is fog/rain/snow, set score to 3, 4, or 5 respectively.

The risk factor determination module 52 receives as input the individual scores 64 for each of the data sources, and the recommendation 60. The risk factor determination module 52 uses the individual scores 64 to determine an overall risk factor 68 for the recommendation 60. When multiple recommendations 60 are provided, the risk factor determination module 52 determines an overall risk factor 68 for each recommendation 60 based on the associated scores 64.

The risk factor determination module 52 determines the risk factor 68 based on risk factor rules 70 stored in the risk factor rules data datastore 58. The risk factor rules data datastore 58 may store one or more risk factor rules 70 for each recommendation 60. The risk factor rules 70 are defined for each recommendation 60 in relation to the scores 64. The risk factor rules 70 may define one or more levels of risk for each recommendation 60. Each level of risk may correspond to a range of numerical values determined by the scores 64 of the associated data sources. For example, a summation of the scores 64 may be computed and the summation may be evaluated by the rules 70.

For example, say there are three levels of risk, risk level (1), risk level (2), and risk level (3). The risk factor rules 70 define a numerical range for each level of risk. Provided an example with five contextual data sources the risk factor rules 70 may include: when the summation X is in the range Xε[5, 6, . . . , 15], set the risk factor to risk level (1); when the summation X is in the range Xε[16, . . . , 20], set the risk factor to risk level (2); and when the summation X is in the range Xε[21, . . . , 25], set the risk factor to risk level (2).

The notification data generation module 54 receives as input the recommendation 60, and the risk factor 68. The notification data generation module 54 generates notification data 72 that is used for notifying the user of the recommendation 60 and the risk factor 68 or simply notifying the user of the risk factor 68. When multiple recommendations 60 and risk factors 68 are provided, the notification data generation module 54 sorts or filters the recommendations 60 based on the risk factors 68. For example, only recommendations having top risk factors 68 (e.g., a top, a top two, a top three, or other number) may be included in the notification data 72. The notification data 72 can include, but is not limited to, display data for displaying the information on the display device, auditory data for announcing the information on the audio device, or haptic data for presenting the information haptically via the haptic device.

In various embodiments, when the notification data 72 includes display data, the display data causes a textual representation of the risk factor 68 and/or the recommendation 60 to be displayed, causes a textual representation of the recommendation 60 to be displayed and a graphical representation of the risk factor 68 to be displayed, causes a graphical representation of the recommendation 60 to be displayed and a textual representation of the risk factor 68 to be displayed, or causes a graphical representation of the risk factor 68 and/or the recommendation 60 to be displayed. For example, the recommendation 60 can be textually displayed in a first text box and a value of the risk factor 68 can be textually displayed in the same or other text box. In various embodiments, the graphical representation of the risk factor 68 may include a gauge or other graphical indicator that displays the risk factor on a numerical or other scale, such as, one provided by color. In various embodiments, the risk factor 68 may include an image associated with the risk levels, or a highlighting of an existing image in a particular color, shading, or boldness associated with the risk levels.

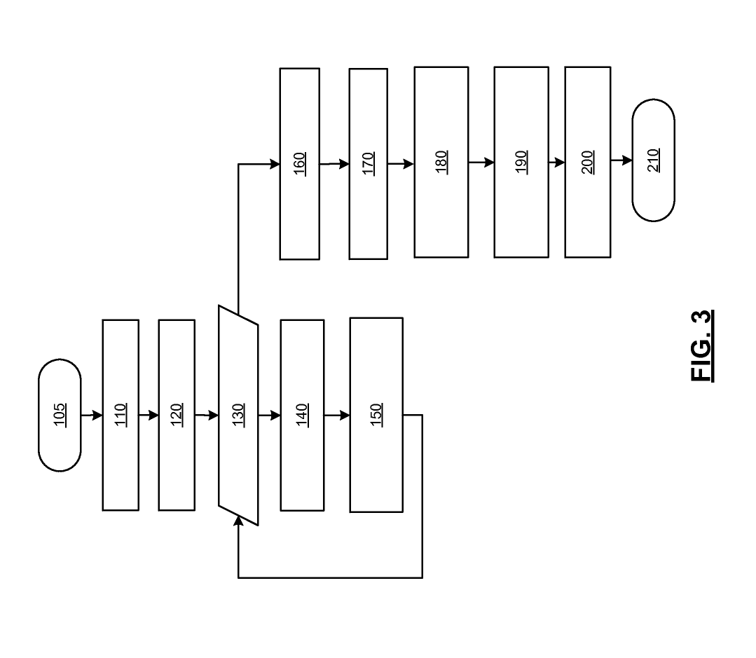

Referring now to FIG. 3 and with continued reference to FIGS. 1-2, flowcharts illustrate recommendation methods that may be performed by the recommendation system 12 in accordance with various embodiments. As can be appreciated in light of the disclosure, the order of operation within the methods is not limited to the sequential execution as illustrated in FIG. 3, but may be performed in one or more varying orders as applicable and in accordance with the present disclosure. As can further be appreciated, one or more steps of the methods may be added or removed without altering the spirit of the method.

In one example, the method may begin at 105. The recommendation(s) 60 is determined at 110. The contextual data 62 associated with the recommendation(s) 60 is determined at 120. For each data source/parameter in the contextual data 60 at 130, the scoring rules 66 for the data source are retrieved from the scoring rules data datastore 56 at 140, and the parameter from the data source is evaluated according to the scoring rules 66 to determine a score 64 at 150. Once all of the scores 64 are determined at 130, the risk factor 68 is determined based on the scores 64 at 160-180.

For example, as summation of the scores 64 is computed at 160 and the risk factor rules 70 associated with the recommendation 60 are retrieved from the risk factor rules data datastore 58 at 170. The summation is then evaluated based on the risk factor rules 70 to determine the risk factor 68 at 180. As can be appreciated, when multiple recommendations 60 are provided at 110, steps 120-180 can be repeated (flow not shown) for each recommendation 60.

The notification data 72 is then determined and generated based on the recommendation(s) 60 and the risk factor(s) 68 at 190. When multiple recommendations are provided, optionally, the recommendations 60 can be sorted and/or filtered based on the risk factors 68 before the notification data 72 is determined. The notification device(s) 40-44 receives the notification data 72 and notifies the user of the recommendation(s) 60 and/or the risk factor(s) 68 at 200. Thereafter, the method may end at 210.

Those of skill in the art will appreciate that the various illustrative logical blocks, modules, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In this disclosure, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of providing decision support, comprising:
receiving a recommendation associated with a vehicle;
receiving contextual data associated with the vehicle;
determining a risk factor based on the recommendation and the contextual data; and
generating notification data based on the risk factor to notify a user of the vehicle of the risk factor associated with the recommendation.

2. The method of claim 1, wherein the recommendation includes a driving maneuver.

3. The method of claim 1, wherein the recommendation includes navigation information.

4. The method of claim 1, wherein the contextual data includes vehicle data.

5. The method of claim 1, wherein the contextual data includes ambient conditions associated with the vehicle.

6. The method of claim 1, wherein the contextual data includes driver data.

7. The method of claim 1, wherein the contextual data is associated with a plurality of data sources, and wherein the determining the risk factor comprises determining a score for each data source associated with the contextual data, and determining the risk factor based on the scores for each data source.

8. The method of claim 7, wherein the determining the score for each data source is based on a scoring rules that are associated with the data source.

9. The method of claim 8, wherein the determining the risk factor further comprises computing a summation of the scores and setting the risk factor based on the summation of the scores.

10. The method of claim 9, wherein the setting the risk factor is based on risk factor rules that are associated with the recommendation.

11. The method of claim 1, wherein the notification data comprises display data to display the risk factor to the user.

12. The method of claim 1, wherein the notification data comprises audio data to play the risk factor to the user.

13. The method of claim 1, wherein the notification data comprises haptic data to haptically provide the risk factor to the user.

14. A system for of processing data, comprising:
a first module that determines a risk factor based on a recommendation associated with a vehicle and contextual data associated with the vehicle; and
a second module that generates notification data based on the risk factor to notify a user of the vehicle of the risk factor associated with the recommendation.

15. The system of claim 14, wherein the recommendation includes at least one of a driving maneuver and navigation information.

16. The system of claim 14, wherein the contextual data includes at least one of vehicle data, ambient conditions associated with the vehicle, and driver data.

17. The system of claim 14, wherein the contextual data is associated with a plurality of data sources, and wherein the first module determines the risk factor by determining a score for each data source associated with the contextual data, and determining the risk factor based on the scores for each data source.

18. The system of claim 17, wherein the first module determines the score for each data source based on a scoring of rules that are associated with the data source.

19. The system of claim 17, wherein the first module determines the risk factor further by computing a summation of the scores and setting the risk factor based on the summation of the scores.

20. The system of claim 19, wherein the first module sets the risk factor based on risk factor rules that are associated with the recommendation.
